(19) United States
(12) Patent Application Publication
(10) Pub. No.: US 2012/0120463 A1
(43) Pub. Date: May 17, 2012

(54) SCANNER

(76) Inventor: Yulun HU, Changsha City (CN)

(21) Appl. No.: 13/157,817

(22) Filed: Jun. 10, 2011

(30) Foreign Application Priority Data
Jun. 11, 2010 (CN) 201020222802.4

(51) Int. Cl. H04N 1/04

(52) U.S. Cl. 358/482; 358/474

(57) ABSTRACT

A scanner comprising a shell with a rut, and a lens arm matching the shape of rut connected with the shell through a revolving shaft. The scanner makes a 180 degree rotation orbiting with the revolving shaft. Lens arm and shell are vertical when in use, resembling the expansion structure of “7.” A flexible pole is retracted when out of use, and the lens arm is folded into the rut of shell. The lens arm and flexible pole are connected by metal revolving shaft as a connecting part, both of which can be set up in the shell to avoid the horizontal bar drooping or being upswept.

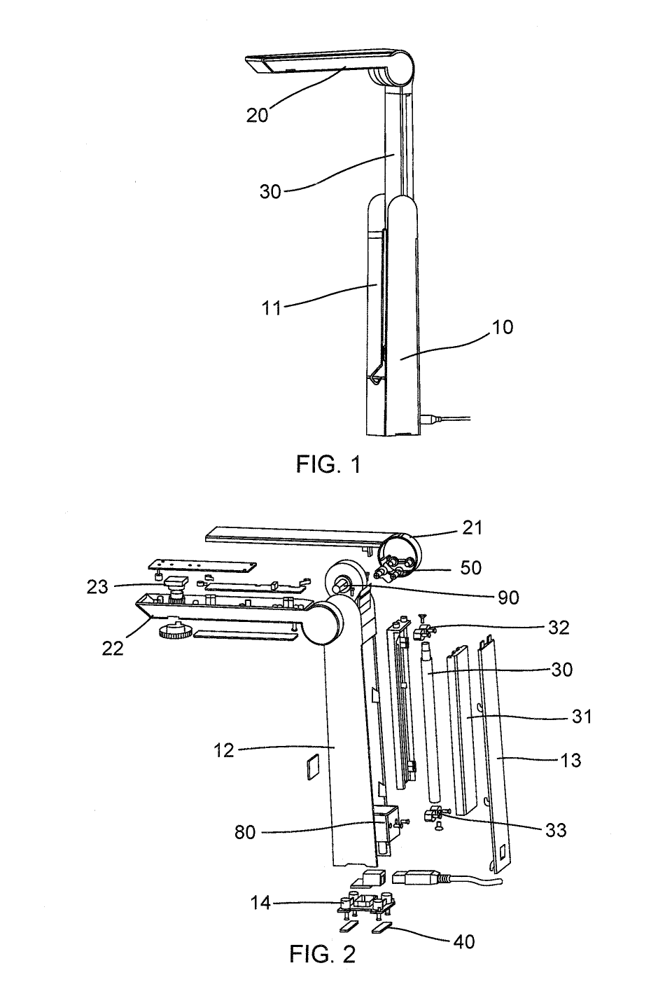

### TECHNICAL FIELD

This Utility Model relates to a kind of scanner.

### BACKGROUND TECHNOLOGY

The popular scanners in present market generally are CCD (Charge-Coupled Device, Photoelectric Coupled Sensor) scanners, which are focusing on CCD through lens, converting the light signal into electrical signal, and performing contacting scanning by sticking tightly on the surface of documents to be scanned. CCD scanner focuses on the CCD for photoreceptive through the lens, which is very convenient for paper document scanning. As technology develops, another kind of image capturing instrument appears in the present market, which is also CCD scanning mode for more convenience. As the present scanners and shooting instruments are applied with the mobile scanning mode of CCD linear array sensor, its scanning speed is relatively slow. Moreover, as the present scanner is flat-type structure, its size is too large to carry.

### SUMMARY

The disclosed scanner is aimed to provide a kind of scanner with a simple structure with fast scanning speed and portable size.

This scanner provides a kind of scanner including a shell with rut and lens arm. The latter includes scanning lens, and lens arm that can be connected vertically with shell and the lens arm matches the shape of rut of shell.

Further, this scanner also includes a flexible pole. One end of the flexible pole is connected with shell, and the other is connected with lens arm by revolving shaft.

Further, the scanning lens includes CMOS area array sensor.

Further, the bottom of the shell is set up with a skid-proof part.

Further, the skid-proof part is foam-rubber cushion.

Further, there is a locating part between the connecting part of lens arm and flexible pole. The lens arm is located in the position of a predetermined angle by the flexible pole through locating part.

Further, lens arm also includes a first-end cover and a second-end cover. The first-end cover and the second-end cover are fixed together through clamping and/or screw. Scanning lens is set up in the space formed by the first-end cover and the second-end cover.

Further, the flexible pole is set up in the space formed by the first flexible pole cover and the second flexible pole cover. And the first flexible pole cover and the second flexible pole cover are fixed on the shell through flexible pole connecting base.

Further, the shell includes a body, a rear cover and a bottom cover. The body and rear cover are connected by chute and/or buckle, and the body and the bottom cover are screwed together.

Further, the shell is also set up with counterweight.

The scanner of this application applies with revolving shaft for lens arm to make within 180 degree rotation orbiting with the revolving shaft. Lens arm and shell are vertical when in use, that is to resemble the expansion structure of “7,” retract the flex pole when out of use, then fold the lens arm into the rut of shell, which is very space-saving and portable. Lens arm and flex pole of the scanner are connected by metal revolving shaft as a connecting part, both of which can be set up in the shell to solve not only the problem of horizontal bar drooping or upswept, but also the large volume of traditional scanners. Moreover, this scanner applies with high resolution CMOS shooting mode, speeding up the scanning speed with strong background processing software, whose speed is more than 10 times of that of traditional scanners.

### DESCRIPTION OF ATTACHED DRAWINGS

One part of the Attached Drawing of this application provides a further understanding of the subject application. The indicative examples and its statement are used to explain the scanner, which should not be construed as limitations for the scanner. In the Attached Drawing:

Drawing 1 is an example structure diagram of a scanner in accordance with aspects of the present application; and

Drawing 2 is an example structure of a scanner in accordance with aspects of the present application.

### DETAILED DESCRIPTION

The followings will describe a scanner by referring to the Attached Drawings and combining with the examples.

Drawing 1 shows a structure diagram of a scanner in connection with Drawing 2. As shown in the Drawings, the scanner may include shell 10 with rut 11, lens arm 20 including scanning lens 23, lens arm 20 which can be connected vertically with shell 10, and the lens arm 20 matches the shape of rut 11 of shell. Revolving shaft 90 is a mental shaft so that it is easily connected and is not easy to be destroyed. Lens arm 20 and shell 10 are connected through revolving shaft 90 for controlling the lens arm 20 and shell 10 to make 90 degree, 150 degrees and 180 degree rotation. By this way, lens arm 20 can be folded into the rut 11 of shell, which reduces the size and is very space-saving for carry.

Referring to both Drawing 1 and Drawing 2, preferably, this scanner may also include flexible pole 30. One end of the flexible pole 30 is connected with shell 10, and the other is connected with lens arm 20 through revolving shaft 90. This flexible pole 30 includes matched multi-section poles to adjust the height of lens 23 conveniently.

Further, scanning lens 23 may include CMOS area array sensor. The lens that applies with high-pixel CMOS shooting mode is speeding up the scanning speed.

Preferably, the bottom of shell 10 is set up with a skid-proof part 40, such that it facilitates anti-proofing and cushion, for example, the anti-proof part 40 can be foam-rubber cushion or other suitable materials.

In some aspects, there is a locating part 50 in the connection between lens arm 20 and flexible pole 30. The lens arm 20 is located in the position of predetermined angle formed by flexible pole 30 through locating part 50. It makes use of the locating part 50 to avoid the droop of lens arm 20 due to the gravity when the lens arm 20 is vertical with shell 10 to maintain the expansion structure of “7.” When the lens arm 20 rotates to 150 degree and 180 degree, the lens arm 20 can be still making video scanning.

In some aspects, lens arm 20 may also include the first-end cover 21 and the second-end cover 22. The first-end cover 21 and the second-end cover 22 are fixed together by clamping and/or screw. The scanning lens 23 is set up in the space formed by a first-end cover 21 and a second-end cover 22. By this way, it is connected tightly. And lens 23 is set up with the lens applying with high resolution CMOS shooting mode, whose focal length can be adjusted. The lens that applies with high resolution CMOS shooting mode is speeding up the scanning speed.

Referring to Drawing 1 and Drawing 2, preferably, flexible pole 30 is set up in the space formed by a first flexible pole cover 31 and a second flexible pole cover 32. And the first flexible pole cover 31 and the second flexible pole cover are fixed on the shell 10 though flexible pole connecting base 33. By this way, it is connected tightly and is easy to take apart and install. Moreover, it is very convenient for use.

In some aspects, shell 10 includes a main body 12, a rear cover 13 and a bottom cover 14. The main body 12 and the rear cover 13 are connected by chute and/or buckle. The main body 12 and the bottom cover 14 are screwed together. By this way, it is connected tightly and is easy to take apart and install. Moreover, it is very convenient for use.

Further, the shell 10 is also set up with counterweight 80. There is counterweight material inside the shell 10, for example, SYD-MRYL. By this way, it can ensure the balance of center of gravity for the overall structure.

The operating steps of this Utility Model of scanner are as follows:

(1) Turn the lens arm 20 to 90 degree, then pull the flexible pole 30 to a certain height.

(2) Press downward the flexible pole 30 and lens arm 20 to the bottom position for capturing an image of a small-sized document.

(3) Pull up the lens arm 20 and flexible pole 30 and the later stretches to the highest position for capturing an image of an A4 document.

(4) Pull the flexible pole to a certain height and turn the lens arm to 150 degree and 180 degree for capturing an image of people.

The foregoing is only a kind of preferable examples for this utility model. It is not the limitation for the disclosed scanner. For technicians in this field, there can be all kind of modifications and changes for the disclosed scanner. Any slight modification, equal change or decoration etc. based on the spirit and principle of this application, shall be contained in the protecting range of this application.

1. A scanner, comprising:
a shell (10) with rut (11):
a Lens arm (20), including scanning lens (23), the lens arm (20) can be connected vertically with the shell (10), and the lens arm (20) matches the shape of the rut (11) of shell.

2. The scanner of claim 1, further comprising a flexible pole (30), wherein one end of the flexible pole (30) is connected with shell (10), and the other end is connected with the lens arm (20) through a revolving shaft (90).

3. The scanner of claim 1, wherein the scanning lens (23) includes a CMOS area array sensor.

4. The scanner of claim 1, wherein the bottom of the shell (10) is set up with skid-proof part (40).

5. The scanner of claim 1, wherein the skid-proof part (40) is foam-rubber cushion.

6. The scanner of claim 1, further comprising a locating part (50) in the connection between the lens arm (20) and the flexible pole (30), and the lens arm (20) is located in the position of a predetermined angle formed by the flexible pole (30) through the locating part (50).

7. The scanner of claim 1, wherein the lens arm (20) also includes a first-end cover (21) and a second-end cover (22), and the first-end cover (21) and the the second-end cover (22) are fixed together by clamping and/or screw, the scanning lens (23) is set up in the space formed by the first-end cover (21) and the second-end cover (22).

8. The scanner of claim 1, wherein the flexible pole (30) is set up in the space formed by a first flexible pole cover (31) and a second flexible pole cover (32), and the first flexible pole cover (31) and the second flexible pole cover are fixed on the shell (10) though flexible pole connecting base (33).

9. The scanner of claim 1, wherein the shell (10) includes a main body (12), a rear cover (13) and a bottom cover (14), the main body (12) and the rear cover (13) are connected by chute and/or buckle, and the main body (12) and the bottom cover (14) are screwed together.

10. The scanner of claim 1, wherein the shell (10) comprises a counterweight (80).
